(19) United States
(12) Patent Application Publication
(10) Pub. No.: US 2020/0069981 A1
(43) Pub. Date: Mar. 5, 2020

(54) METHOD OF PROTECTING AN OBJECT AGAINST FIRE AND FIRE PROTECTIVE COVERING FOR AN OBJECT

(71) Applicant: Favuseal AS, Rud (NO)

(72) Inventor: Christian Schlytter-Henrichsen, Rud (NO)

(21) Appl. No.: 16/610,014

(22) PCT Filed: May 3, 2018
(86) PCT No.: PCT/EP2018/061319

§ 371 Date: Oct. 31, 2019

(30) Foreign Application Priority Data
May 3, 2017 (EP) 17169186.8

(51) Int. Cl. A62C 2/06

(52) U.S. Cl. CPC A62C 2/065; A62C 99/0009

(57) ABSTRACT

The invention relates to a method of protecting an object (1) against fire. An endothermic material (2) is arranged around the object (1), and then an outer metal-containing cladding (5) is arranged so that it covers at least a part of the endothermic material (2). The endothermic material (2) is provided as a tape (3) which is applied by helically winding the tape (3) in an overlapping manner resulting in a stepped outer surface (6) facing towards the outer cladding (5). The outer cladding (5) comprises metal, in particular is made of metal. The stepped outer surface (6) results in air cavities (7) being formed underneath the outer cladding (5). When the object (1) is exposed to a fire, such small air cavities (7) will allow for a slight swelling of the endothermic material (2) that will, as a consequence of the fire, react and release water directly to the outer cladding (5) from underneath and thereby provide cooling thereof.

### FIELD OF THE INVENTION

The present invention relates to a method of protecting an object against fire. In particular, it relates to a method by which it is possible to prolong the time for which an outer cladding covering the object remains intact in case of exposure to fire, such as hydrocarbon fire or jet fire. The invention also relates to a method by which the outer dimension of the outer cladding remains substantially unchanged before and after being exposed to fire.

### BACKGROUND OF THE INVENTION

Passive fire protection is used to protect objects against fire to retard the spreading of the fire and avoid loss of integrity of the object being protected. In general, such objects include electric cables, pipes and tanks conducting or containing hydrocarbons or other flammable materials, ventilation ducts, safety deposit boxes, penetration seals for cables and pipes in walls etc. Heat sources causing hazardous risks to an object include cellulosic fire, hydrocarbon fire, jet fire, hot gases, infrared radiated heat etc. According to ISO 834-3, hydrocarbon fire results in heat exposure up to 200 kW/m², and jet fire results in heat exposure exceeding 200 kW/m².

Known passive fire protection methods comprise the use of structural components, such as fire-resistant walls, floors, and doors. It may also be in the form of e.g. an insulating layer of mineral fibres which will delay the heat from the fire in reaching the protected object on the “cold” side of the insulating layer. Other known technologies use intumescent materials which upon heating will expand and increase in volume. An example of such a type of material is known from CN201812530.

Still other technologies use materials which upon heating will go through one or more phases in which the material will react chemically and/or physically with one or more endothermic reactions, e.g. where hydrates are spent and water vapour is released, which has a cooling effect. Materials with such endothermic properties include polymer-based materials and rubber-based materials which can be applied to the surface of the object to be protected.

For some applications, fire protection of an object is provided in the form of the mentioned fire protection technologies, but with a metal-based outer cladding providing mechanical integrity to the technology used for the passive fire protection. Such a metal-based cladding also provides mechanical protection e.g. against wear and tear, and influence from the weather, and it removes any erosion issues related especially to any jet fire curves. However, at high temperatures in case of fire, and in particular hydrocarbon fire and jet fire, there is a risk that the metal cladding will erode and melt away resulting in failure of the adopted fire protection technology.

Oil installations around the world are becoming more and more complex. Consequently, more equipment is placed on them and they are now very condensed and may e.g. have several pipes arranged adjacent to each other. If such pipes are fire protected with an intumescent paint based system, the intumescent paint will be designed to expand by upto 500-900% from its original state in case of exposure to fire. This expansion is required for the paint to build up a thermal barrier against the heat and, consequently, delay the time it takes for the heat to penetrate the reacted paint. If such expansion is interrupted, e.g. due to lack of free space, the technology does not work as intended and it will fail in providing the desired protection.

Hence, an improved method of protecting an object against fire would be advantageous, and in particular a more efficient and/or reliable method would be advantageous.

### OBJECT OF THE INVENTION

It is an object of the present invention to provide a method of protecting an object against fire which results in a longer time to failure of an outer cladding covering the object for a given fire scenario.

It is another object of the present invention to provide a method of protecting an object against fire that can be applied to an already installed object.

It is an object of at least some embodiments of the invention to provide a method of protecting an object against fire with which the outer diameter of an outer cladding remains substantially the same before and after being exposed to fire.

It is a further object of the present invention to provide an alternative to the prior art.

In particular, it may be seen as an object of the present invention to provide a method of protecting an object against fire that solves the above mentioned problems of the prior art.

### SUMMARY OF THE INVENTION

Thus, the above-described object and several other objects are intended to be obtained in a first aspect of the invention by providing a method of protecting an object against fire, the method comprising:
arranging an endothermic material around the object so that it covers at least a part of the object, and
arranging an outer cladding covering at least a part of the endothermic material,

wherein the endothermic material is provided as a tape which is applied by helically winding the tape in an overlapping manner resulting in a stepped outer surface facing towards the outer cladding, and

wherein the outer cladding comprises metal, such as is made from metal.

By “endothermic material” is preferably meant a material which when subjected to heat undergoes a phase-changing state incorporating one or more endothermic reaction processes. As this is an energy-demanding reaction, some of the heat from the fire will be consumed by the endothermic process and thereby delay the increase in temperature of the object to be protected. More importantly, it will also increase the time to failure of the outer cladding covering the endothermic material, as it will, in effect, cool down the cladding from the inside and consequently prolong the time to failure of the outer cladding.

By “tape” is preferably meant in the form of a band having a width and being long enough to be wound several times around the object. The specific length for a given application depends on the size of the object to be protected and the amount of overlap between subsequent windings. The term “a band” does not exclude that the endothermic material can be in the form of successively arranged separate tapes of material.

The stepped outer surface results in air cavities being formed underneath the outer cladding; this will be shown in relation to the figures. When the object is exposed to a fire and the thermal load of the fire hits the outer cladding, such small air cavities will allow for a slight swelling of the endothermic material that will, as a consequence of the fire, react and release water directly to the outer cladding from underneath. As mentioned, this particular reaction process will cool down the outer cladding from underneath and prolong the time until failure and consequently breach of the cladding itself. Thus, arranging the components of the fire protection as described above will inherently increase the integrity of the outer cladding by preventing or delaying e.g. metal melt down, or deformation of the outer cladding itself.

In presently preferred embodiments of the invention, the outer cladding is arranged in direct contact with the endothermic material. Hereby the cooling effect of the endothermic material can be directly applied to the outer cladding so that the cooling is as efficient as possible. Due to the stepped outer surface of the endothermic material, the direct contact will be where the diameter of the wound endothermic material is largest; this will be shown in the figures. Alternatively, a layer of intermediate material may be arranged between the endothermic material and the outer cladding to provide further protection. Such a material may e.g. be used to provide protection against moisture. However, such an intermediate layer should not limit the cooling effect by any significant amount.

An overlap between subsequent windings of the tape of endothermic material may be 20 to 80% of a width of the tape, such as 25 to 50%.

In some embodiments of the invention, more than one layer of the endothermic material is applied. This may e.g. be necessary to fulfil the requirements in a given fire class.

The outer cladding may be made steel. An example of a steel typically used for fire protective claddings is AISI 316 SS. Such a metal cladding has been found useful in relation to hydrocarbon fire scenarios (1,100° C.) or jet fire scenarios (1,200-1,500° C.). Thus, the outer cladding may be dimensioned and shaped so that the outer diameter thereof remains substantially the same before and after the outer cladding has been exposed to temperatures above 1,100° C., such as temperatures between 1,200 and 1,500° C. Keeping the outer dimension constant in a fire is regarded advantageous as land-terminals, oil rigs, Floating Production Storage and Offloading vessels, and Floating Liquified Natural Gas vessels are becoming more complex and condensed with respect to e.g. pipework.

Traditionally used expandable fire protection technologies require free space in order to work as they might expand by upto 500-900% from their virgin state. As described above, if such an expandable technology is not allowed to fully expand freely, it will loose its inherent fire protection properties, and the technology will not work as intended. Therefore, with traditionally used fire protection technologies based on expanding materials, it is very important to make sure that the material is free to expand. However, there is not always room for this. It is therefore an advantage of the present invention that with such a method, the outer dimension of the outer cladding remains substantially unchanged before and after being exposed to fire.

Examples of other materials which may also be used for the outer cladding are aluminium covering, silica tape reinforced with steel wiring, Zink-based covering, stainless steel metal covering, and glass fibre reinforced polymer (GRP) covering reinforced with steel wiring.

The endothermic material may be a rubber-based or a polymer-based material. In some embodiments of the invention, the endothermic material may be a material which will, at a first elevated temperature, undergo a first endothermic process during which water is released and evaporated and, at a second elevated temperature higher than the first elevated temperature, undergo a second endothermic process during which a physically and thermally stable fire barrier is created. An example of such a material will be presented in the detailed description.

The endothermic material may contain inorganic fillers in a binder. It may e.g. be a thermoplastic material composed of a co-polymer, such as an ethylene co-polymer. Such a technology has proven to be robust to weathering conditions over time and fluctuations in temperature.

In some embodiments of the invention, the object to be protected has already been installed before the endothermic material and the outer cladding are arranged thereon. Thus, the method can be used to up-grade the fire resistance of an object and thereby possibly of a whole installation of which it forms part.

In a second aspect, the present invention relates to a fire protective covering for an object, the covering comprising:
an endothermic material provided as a tape and adapted to be helically wound around the object in an overlapping manner resulting in a stepped outer surface facing towards an outer cladding, and
the outer cladding adapted to be arranged so that it covers at least a part of the endothermic material, and

wherein the outer cladding comprises metal, such as is made from metal.

The outer cladding may made from steel, such as AISI 316 SS.

The outer cladding may dimensioned and shaped so that the outer diameter thereof remains substantially the same before and after the outer cladding has been exposed to temperatures above 1,100° C., such as temperatures between 1,200 to 1,500° C.

The first and second aspects of the present invention may each be combined with any of the other aspects. This means that the features now described in relation to the first aspect is also possible features of the second aspect of the invention.

These and other aspects of the invention will be apparent from and elucidated with reference to the embodiments described hereinafter.

### BRIEF DESCRIPTION OF THE FIGURES

The method of protecting an object against fire according to the invention will now be described in more detail with regard to the accompanying figures. The figures show one way of implementing the present invention and is not to be construed as being limiting to other possible embodiments falling within the scope of the attached claim set.

FIG. 1 schematically shows an object to be protected against fire, the object having an endothermic material helically wound around it.

FIG. 2 schematically and in partial view shows how the helical winding of the tape of endothermic material results in air cavities being formed underneath the outer cladding.

### DETAILED DESCRIPTION OF AN EMBODIMENT

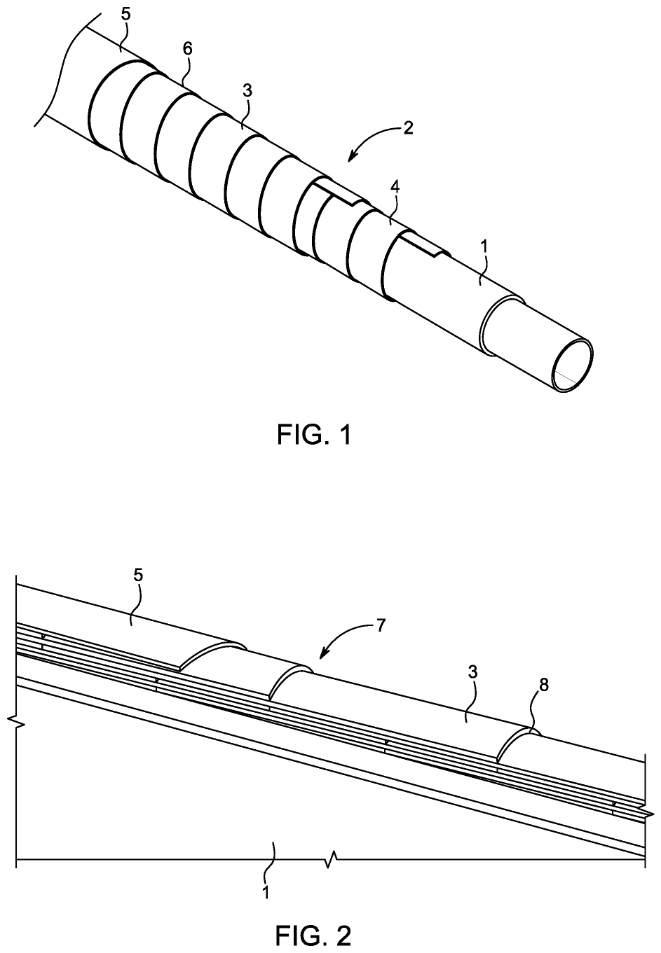

FIG. 1 schematically shows how an object 1 can be protected against fire by use of a method according to the present invention. The illustrated object 1 is in the form of a pipe, but the method can be used in relation to any geometry which is adapted to receive the wound material. The method comprises arranging an endothermic material 2 in the form of a tape 3 around the object 1 so that it covers at least a part of the object 1. In the embodiment in FIG. 1, the object 1 has two layers helically wound around it. The overlap between subsequent windings of the tape 3 is typically between 20 to 80% of a width of the tape, such as 25 to 50%. However, any amount of overlap is covered by the scope of the present invention. The outermost of the layers is an endothermic material. The innermost layer 4 may also be an endothermic material, such as the same in the outermost layer 3, but it may also be another material providing other types of protection to the object 1, such as thermal insulation or moisture protection. It can e.g. be a fibre-based material with fibres made from stone wool, Alcali Earth Silicates, or glass fibre impregnated aerogels. An outer cladding 5 is arranged to cover at least a part of the endothermic material 2. In FIG. 1, the outer cladding 5 covers only a small part of the endothermic material 2, but that is for illustrative purposes only; i.e. to more clearly illustrate the endothermic material. In a real use, the outer cladding 5 would typically cover all or most of the endothermic material 2.

As shown in FIG. 1, the endothermic material is provided as a tape 3 which is applied by helically winding the tape 3 in an overlapping manner resulting in a stepped outer surface 6 facing towards the outer cladding 5.

FIG. 2 schematically shows a part of the embodiment in FIG. 1. The figure illustrates how the helical winding of the tape 3 of endothermic material results in air cavities 7 being formed underneath the outer cladding 5 at the edges 8 of the tape 3. Preferably, the outer cladding 5 is arranged in direct contact with the endothermic material so that an efficient cooling of the outer cladding 5 can be ensured.

As explained above, such an arrangement means that when the object 1 is exposed to a fire, and the thermal load of the fire hits the outer cladding 5, such small air cavities 7 will allow for a slight swelling of the endothermic material 2 that will, as a consequence of the fire, absorb some of the heat and initiate an endothermic reaction. This particular reaction process will therefore prolong the time until failure and consequently breach of the outer cladding 5 itself.

The outer cladding 5 is typically made from a metal, such as steel. An example of a steel typically used for fire protective claddings is AISI 316 SS. However, other materials are also covered by the scope of protection.

The endothermic material 2 is preferably a rubber-based or a polymer-based material. In some embodiments of the invention, the endothermic material 2 is a material which will, at a first elevated temperature, undergo a first endothermic process during which water is released and evaporated and, at a second elevated temperature higher than the first elevated temperature, undergo a second endothermic process during which a physically and thermally stable fire barrier is created. Such a first endothermic process will cool down the outer cladding 5 from underneath and consequently prolong the time to failure. Such a second endothermic process typically results in the formation of a physically and thermally stable substance forming a fire barrier and will also, to some extent, cool off the outer cladding prolonging the time to failure. The resulting thermally stable substance may have a low thermal conductivity, and as a result, will delay the heat penetration considerably in time, and yield further protection against damage of the object 1.

An example of an endothermic polymer-based material which can be used in relation to the present invention is the product FAVUSEAL® NKX-6174 available from Favuseal AS, Norway. FAVUSEAL® NKX-6174 is a thermoplastic material containing inorganic fillers in a binder composed of an ethylene copolymer. It may e.g. be an ethylene vinyl acetate (EVA) based material which is highly filled with Alumina Tri-hydrate, which will lead to a very strong endothermic reaction process when exposed to temperatures in excess of 180° C. The second endothermic reaction process starts at 700-800° C. where a micro-porous steady state ceramic will be generated. This particular micro-porous state will have a very low thermal conductivity coefficient when, for instance, the invention is exposed to a standard 250 kW/m² jet fire. The thermal conductivity coefficient has been identified by numerous jet fire tests conducted to be at 0.05 (W/m/K) at 1,000° C. and 0.04 at 1,300° C. for various jet fire scenarios.

During exposure to flame or heat, FAVUSEAL® NKX-6174 goes through the following stages of transformation:
90° C. Softening
200° C. Evolution of water, swelling
300° C. Pyrolysis of the polymeric binders
800° C. Formation of rigid cellular ceramics stable up to 1,500° C.

When FAVUSEAL® NKX-6174 is subjected to heat, for example in a fire, two phase transitions take place. The first phase transition takes place between 200 and 250° C. and the second phase transition takes place between 700 and 800° C. At the first phase transition, crystal water is generated from the O—H groups in the fillers. The water evaporates and the reaction is strongly endothermic, i.e. heat absorbing. The temperature behind the barrier of FAVUSEAL NKX-6174 will not exceed approximately 300° C. as long as this reaction takes place because this process actually consumes energy which is used to release the water. The second phase transition is at 700-800° C. creating a solid micro-porous ceramic substance with extreme very low thermal conductivity which also is physically stable.

The method according to the present invention may be used to add fire protection properties to an object 1 which has already been installed before the endothermic material 2 and the outer cladding 5 is arranged thereon. Alternatively, the fire protection may be applied as part of the initial installation process.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. In addition, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method of protecting an object against fire, the method comprising:
arranging an endothermic material around the object so that it covers at least a part of the object, and
arranging an outer cladding covering at least a part of the endothermic material,
wherein the endothermic material provided as a tape which is applied by helically winding the tape in an overlapping manner resulting in a stepped outer surface facing towards the outer cladding, and
wherein the outer cladding comprises a metal, such as is made from metal.

2-13. (canceled)

14. The method according to claim 1, wherein the outer cladding is in direct contact with the endothermic material.

15. The method according to claim 1, wherein an overlap between subsequent windings of the tape is 20 to 80% of a width of the tape.

16. The method according to claim 1, wherein more than one layer of the endothermic material is applied.

17. The method according to claim 1, wherein the outer cladding is made from steel.

18. The method according to claim 1, wherein the outer cladding is dimensioned and shaped so that the outer diameter thereof remains substantially the same before and after the outer cladding has been exposed to temperatures above 1,100° C.

19. The method according to claim 1, wherein the endothermic material is a rubber-based or a polymer-based material.

20. The method according to claim 1, wherein the endothermic material is a material, which will, at a first elevated temperature, undergo a first endothermic process during which water is released and evaporated and, at a second elevated temperature higher than the first elevated temperature, undergo a second endothermic process during which a physically and thermally stable fire barrier is created.

21. The method according to claim 1, wherein the endothermic material comprises an inorganic filler in a binder.

22. The method according to claim 1, wherein the object has been installed before the endothermic material and the outer cladding are arranged thereon.

23. A fire protective covering for an object, the covering comprising:
an endothermic material provided as a tape and configured to be helically wound around the object in an overlapping manner resulting in a stepped outer surface facing towards an outer cladding,
wherein the outer cladding is configured so that it covers at least a part of the endothermic material, and
wherein the outer cladding comprises a metal.

24. The fire protective covering according claim 23, wherein the outer cladding is made from steel.

25. The fire protective covering according to claim 23, wherein the outer cladding is dimensioned and shaped so that the outer diameter thereof remains substantially the same before and after the outer cladding has been exposed to temperatures above 1,100° C.
